(19) United States
(12) Patent Application Publication
(10) Pub. No.: US 2008/0074869 A1
(43) Pub. Date: Mar. 27, 2008

(54) Lighting apparatus

(75) Inventor: Kiyoshi Okishima, Tokyo (JP)

Correspondence Address: GREER, BURNS & CRAIN, 300 S WACKER DR, 25TH FLOOR, CHICAGO, IL, 60606, US

(73) Assignee: Sanyo Tecnica Co., Ltd., Tokyo (JP)

(21) Appl. No.: 11/903,195

(22) Filed: Sep. 20, 2007

(30) Foreign Application Priority Data
Sep. 22, 2006 (JP) 2006-256831

(51) Int. Cl. F21L 4/02

(52) U.S. Cl. 362/184

(57) ABSTRACT

A lighting apparatus that can operate longer utilizing a battery is provided. A lighting apparatus comprises a battery, switch means, at least two types of light sources, the power consumption of each being different from each other, capable of being connected to the battery via the switch means, voltage detection means for detecting a voltage of the battery, and switch control means for controlling the switch means to switch the connection target of the battery between the at least two types of light sources in response to the output signal of the voltage detection means.

### BACKGROUND OF THE INVENTION

1. Field of the Invention

The present invention relates to lighting apparatuses and, more particularly, to a lighting apparatus that can make it possible to prolong a period in which the light apparatus can illuminate utilizing one and same battery.

2. Description of the Related Art

Conventionally, a dry battery or rechargeable secondary battery has been used in a flashlight, a head lamp for use in construction work, disaster-relief work or mining work, or a lamp for use in sports such as fishing and climbing. Typically, when its voltage falls below a predetermined voltage, a dry battery will be discarded and replaced with a new one, while a secondary battery is reiterataly used as a reproduced one which has been recharged with a battery charger.

For these types of lighting apparatuses, however, one lighting apparatus is provided with an only one type of light source with a certain lighting power, and is designed to load a dry battery or secondary battery with a power corresponding to the light source.

Therefore, if higher-intensity lighting is needed, a light source with higher intensity and higher power is used, and simultaneously with this a dry battery or a secondary battery with a power capable for driving such a light source should be used.

It is known that those batteries described above have specific discharging characteristic individually. During driving a given light source to illuminate, the output voltage of its battery decreases gradually according to the respective discharging characteristic. When the voltage falls below a termination voltage, i.e. a minimum voltage for illuminating the light source, the battery can no longer drive the light source and need to be replaced with a new one or recharged.

However, even after the output voltage of the battery falls below the termination voltage which enables the driving of a given light source, the battery still has some level of residual capacity, and immediately discarding or recharging the battery would be a big economic loss.

On the other hand, there are many use patterns of the lighting apparatus in which an operation of the illumination with high intensity is needed in a first predetermined duration though, after such duration, it is preferable for the illumination to be maintained for a long time even with low intensity.

In the case of night work at a construction site, for example, there are many cases in which bright lighting may be needed for a first some hours though, and after that, it is possible to perform necessary works under dark bright lighting. If a work to be done the next day can be completed in the same day in such a way, the working efficiency would be improved, and the increase of cost and the degradation of efficiency caused by prolonging the working hours could be avoided.

This is also true for a disaster-relief work. For a flashlight or head lamp for climbing, bright lighting may be needed in the beginning of walking, but, when eyes adjust to darkness after a long walk, less bright lighting may be enough for keeping safety in climbing.

Also, as is often the case with a float or in-water fish lamp for use in fishing, bright lighting may be needed at the beginning, and afterward, there are many cases in which only the position of the float or fish lamp can be seen, with dark bright lighting.

As a result of consideration on battery characteristics, the present inventor found that, when a certain light source is driven by a predetermined battery, as described above, and when the output voltage of the battery falls below its termination voltage specific to the battery with respect to the certain light source, if the battery, which may be discarded or recharged in a conventional way, is connected to a separate light source having a load lighter than that of the certain light source (i.e. consumes lower power), the output voltage of the battery will increase, and the battery will be able to drive the separate light source of lower power consumption for a fairly long time with same battery since the termination voltage is reached.

Base on the result, the present inventor has developed a lighting apparatus that can continue to use a battery for a long time without being discarded or recharged as in a conventional way after the battery can no longer drive a given light source, which eliminates an economic loss, delay of work or complicated operation.

### SUMMARY OF THE INVENTION

The present invention was made to resolve the conventional problem as described above, and it is an object of the present invention to provide an inexpensive, efficient lighting apparatus capable of providing desired lighting for a long time using a battery, with a simple configuration.

In order to achieve the above object, the lighting apparatus in accordance with the present invention employs a basic technical configuration as follows.

An aspect in accordance with the present invention provides a lighting apparatus including: a battery; switch means; at least two types of light sources, the power consumption of each being different from each other, capable of being connected to the battery via the switch means; detection means for detecting a voltage of the battery; and switch control means for controlling the switch means to switch the connection target of the battery between the at least two types of light sources in response to the output signal of the detection means.

Employing the technical configuration as described above, the lighting apparatus in accordance with the invention can continue to use a battery for a long time, though the brightness of the light will change at a certain point. Such a lighting apparatus is efficient and economical, and has a desirable configuration from the viewpoint of environmental and energy conservation because of prolonged life before being discarded.

### BRIEF DESCRIPTION OF THE DRAWINGS

FIG. 1 is a block diagram showing the configuration of a lighting apparatus in accordance with a specific example of the present invention;

FIG. 2 shows an appearance of an example in which a lighting apparatus in accordance with the present invention is used in a flashlight;

FIG. 3 is a graph showing an example of the discharging characteristic of a battery; and

FIG. 4 is a schematic circuit diagram showing an example of the configuration of the lighting apparatus in accordance with the present invention.

### DETAILED DESCRIPTION OF THE PREFERRED EMBODIMENT

A lighting apparatus in accordance with a specific example of the present invention will be described below in detail with reference to the accompanying drawings.

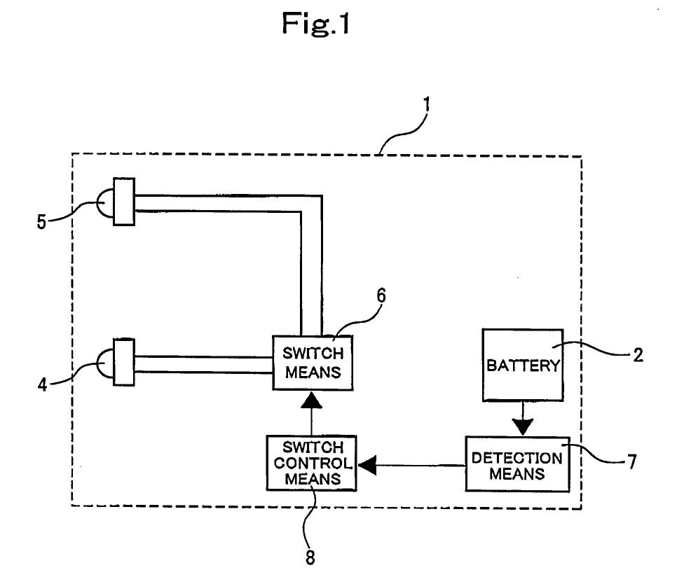

FIG. 1 is a block diagram showing the configuration of a lighting apparatus 1 in accordance with a specific example of the present invention. The lighting apparatus 1 includes: a battery 2; switch means 6; at least two types of light sources 4, 5, the power consumption of each being different from each other, capable of being connected to the battery 2 via the switch means 6; voltage detection means 7 for detecting a voltage of the battery 2; and switch control means 8 for controlling the switch means 6 to switch the connection target of the battery 2 between the at least two types of light sources 4, 5 in response to the output signal of the voltage detection means 7.

Configuration, type or form of the battery 2 is not particularly specified, but preferably, the battery 2 of the present invention is one selected from the group consisting of dry batteries, rechargeable secondary batteries, storage batteries, fuel cell batteries, and solar batteries, all of which being conventionally known and commercially available, that can generate direct current.

The rated capacity of the battery 2 is also not particularly specified, and preferably, the battery 2 has enough capacity for driving the one consuming larger power among the light sources 4, 5.

The lighting apparatus 1 needs to use at least two types of light sources. Specifically the lighting apparatus 1 includes a first light source 4 and a second light source 5, the first light source 4 consuming more power and providing higher-intensity lighting than those of the second light source 5.

The number of the light sources is not limited to two, but three or more light sources, the power consumption of each being different from each other, can also be used in combination.

For example, the first light source may be a high-intensity lamp, a halogen lamp, an HID lamp, or a high-wattage lamp, while the second light source may be a low-intensity lamp, a low-wattage lamp, or an LED lamp.

As mentioned above, each type of the battery 2 has a unique discharging characteristic, as shown in FIG. 3, which varies depending on the load or power consumption of the light source to be driven.

In FIG. 3, a curve 3 shows the discharging characteristic of a given battery 2, when used to drive a light source 4 including a given lighting load, where the vertical and horizontal axes represent the output voltage of the battery 2 and the elapsed time, respectively.

Such a discharging characteristic curve will vary depending on the type, rating or material of the battery, ambient temperature, load resistance, etc., but its pattern will be almost the same.

For example, when a battery 2 of 12 V is used to light an HID lamp of 2.7 A consumption current, the output voltage of the battery 2 decreased to 8 V about an hour later, and can no longer light the HID lamp.

This means that, in this case, the termination voltage 9 of the battery 2 was 8 V. From that moment on, the battery 2 can no longer light the HID lamp, but still has some level of residual capacity. Then a LED 5 of 0.15 A is connected, in place of the HID lamp of the lighting apparatus 1, to the battery 2, and it is observed that voltage higher than 8 V was obtained, which is enough for lighting the LED 5. After that, the LED 5 continued to light for 24 hours.

The technical background of this phenomenon is explained below referring to FIG. 3. The basic information for considering the discharging characteristic of a battery is a battery capacity of the battery.

The battery capacity is typically defined by the amount of electricity that can be obtained from the battery until the terminal voltage of a full charged battery decreases to a termination voltage, i.e. a predetermined end-of-discharge voltage by discharging.

Such a battery capacity may currently be expressed, for example, as 1 hour rate capacity, 5 hour rate capacity, 10 hour rate capacity, 20 hour rate capacity, etc., and typically 5 hour rate capacity is used. 5 hour rate capacity is defined as capacity discharged until the output voltage of a battery decreases to a predetermined end-of-discharge voltage with constant discharge current (5 hour rate current, i.e. one fifth of 5 hour rate capacity). Thus 5 hour rate capacity is expressed by the product of the constant discharge current and the discharge duration until the end-of-discharge voltage is reached.

This means that the magnitude of the discharge current has an influence on the amount of electric energy that can be obtained from the battery. Specifically, for example, the larger the discharge current is, the shorter the discharge duration is, and the smaller the discharge current is, the larger the electric energy obtainable from the battery is.

The present invention makes effective use of this technical background and makes it possible to effectively obtain electric energy corresponding to the residual capacity of the battery by connecting another lighting means of less power consumption to the battery having reached the termination voltage to decrease the consumption current and termination voltage.

The switch control means 8 used for the invention may have any configuration capable of switching the connection of the switch means 6 in response to the detection result from the voltage detection means 7.

The switch control means 8 may naturally be composed of electronic circuit elements such as FET.

The switch means 6 used for the invention may have any configuration capable of selectively switching the connection target of the battery between the first and second light source according to the control signal from the switch control means 8.

Thus, in this specific example of the invention, at first, the battery 2 is connected to the first light source 4 of larger power consumption to drive the first light source 4, the output voltage of the battery 2 being always detected by an appropriate voltage detection means 7. When the voltage detection means 7 detects that the output voltage of the battery 2 falls below a predetermined voltage, i.e. a termination voltage, the voltage detection means 7 outputs an information signal indicating the detection result to an appropriate switch control means 8, and then, the switch control means 8 automatically disconnects the battery 2 from the first light source 4 and connects the battery 2 to the second light source.

In short, in accordance with the invention, the lighting operation is automatically switched from the first light source 4 to the second light source 5 without the intervention of an user of the lighting apparatus, which is convenient for the user.

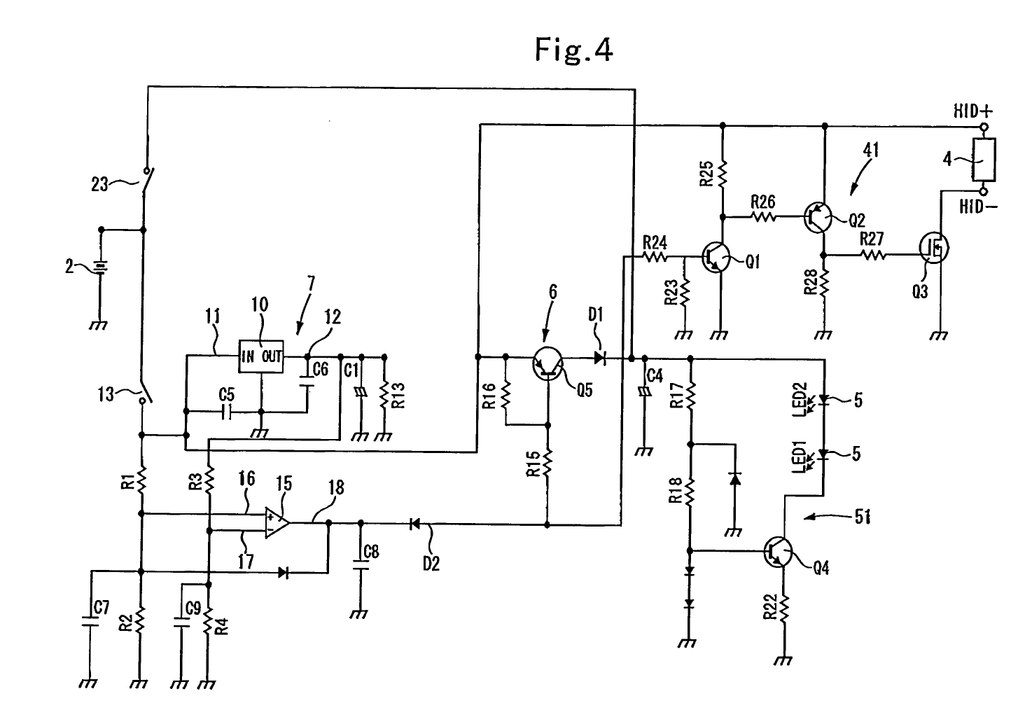

Next, a specific circuit configuration of a lighting apparatus in accordance with the invention will be described with reference to FIG. 4.

As shown in FIG. 4, a three-terminal voltage regulator 10 with the input terminal 11 connected to the positive terminal of a battery 2 via a main switch 13 gives an output voltage of regulated constant level from the output terminal 12.

The positive terminal of the battery 2 is also connected to one input terminal 16 of a comparator 15 via the main switch 13 and a resistor R1. The other input terminal 17 of the comparator 15 is connected to the output terminal 12 of the three-terminal voltage regulator 10 via a resistor R3. An resistor R2 is connected between the terminal 16 and the ground. A resistor R4 is connected between the terminal 17 and the ground. In this way, the comparator 15 monitors the output voltage of the battery 2 using the regulated voltage divided by the resistor R3 and R4 as a reference voltage (for example, being set to a termination voltage as described above).

An HID lamp lighting control circuit 41 for driving an HID lamp 4 controls on and off of the HID lamp 4 by controlling on/off state of a switching transistor Q3 via switching transistors Q1, Q2. In the HID lamp lighting control circuit 41, the HID lamp 4 is lighted when the base voltage of the switching transistor Q1 exceeds a predetermined voltage.

An LED lighting control circuit 51 drives LEDs 5, 5. When the base voltage of the switching transistor Q4 exceeds a predetermined voltage, the switching transistor Q4 is in on-state and the LEDs 5, 5 are lighted.

A switching circuit 6 synchronously controls the switching of on/off of the HID lamp 4 and off/on of the LEDs 5, 5.

The switching circuit 6 is composed of a switching transistor Q5 with the emitter connected to the input terminal 11 of the three-terminal voltage regulator 10, the collector connected via a diode D1 to the LED lighting control circuit 51 for driving the LEDs 5, 5, and the base connected to the output terminal 18 of the comparator 15 via a resistor R15 and a diode D2 and connected to the base of the switching transistor Q1 of the HID lamp lighting control circuit 41 via resistors R15, R24.

A resistor R16 connected between the base and emitter of the switching transistor Q5 controls the voltage between the base and emitter of the switching transistor Q5.

A switch 23 is provided to light the LEDs 5, 5 when needed.

In the lighting apparatus in accordance with the invention, configured in this way, when the main switch 13 is switched on, the output voltage of the battery 2 is applied to the three-terminal voltage regulator 10, a regulated voltage output by the three-terminal voltage regulator 10 is applied to the terminal 17 of the comparator 15, and the output voltage of the battery 2 is also applied to the terminal 16 of the comparator 15. Accordingly, if the battery 2 is fresh, the output 18 of the comparator 15 is high voltage. The output voltage of the battery 2 is also applied to the base and emitter of the switching transistor Q5 of the switching circuit 6, which brings the diode D2 to off-state, allowing only a little current flowing through a resistor R16 and the resistor R15 to flow through the resistors 24, 23, and consequently, the switching transistor Q5 is in off-state and the LEDs 5, 5 are not lighted.

On the other hand, as described above, bias current flows through the resistor R24 connected to the base of the switching transistor Q1 of the HID lamp lighting control circuit 41, which brings the switching transistor Q1 to on-state, increasing the gate voltage of the switching transistor Q3 to light the HID lamp 4.

At this point, the LEDs 5, 5 are not lighted, but can be lighted if needed by switching the switch 23 on to feed current from the battery 2 to the LED lighting control circuit 51 via the switch 23.

If the HID lamp 4 is continuously lighted, the output voltage of the battery 2 will decrease.

When the comparator 15 detects that the output voltage of the battery 2 falls below a predetermined voltage, the output 18 of the comparator 15 changes to a low voltage of almost 0 V. Accordingly, the diode D2 changes to on-state; large current flows through the resistors R16, R15; the base bias voltage of the switching transistor Q5 increases; the switching transistor Q5 changes to on-state; current is fed to the LED lighting control circuit 51; and the LEDs 5, 5 are lighted.

At the same time, the base voltage of the switching transistor Q5 decreases; the base bias voltage of the switching transistor Q1 of the HID lamp lighting control circuit 41 decreases; the switching transistor Q1 changes to off-state; and the HID lamp 4 is turned off.

As described above, in accordance with the invention, when the first light source 4 is connected to the battery 2 and lighted, and the voltage detection means 7 detects the termination voltage of the battery 2 specific to the first light source 4, the switch control means 8 desirably controls the switch means 6 to disconnect the first light source 4 from the battery 2 and connect the second light source 5 to the battery 2.

In accordance with the invention, any type of light source may be used as the first light source 4 and second light source 5 depending on an application, purpose, operating time, etc. of the lighting apparatus 1.

For example, a HID lamp and LED, as described above, or a halogen lamp and LED may be used for the first light source 4 and second light source 5, respectively.

Also, a 100 W light bulb and 20 W bulb may be used for the first light source 4 and second light source 5, respectively.

The number of the first light source 4 need not be the same as the second light source 5. In some case, a larger number of the second light source 5 than the first light source 4 may be used.

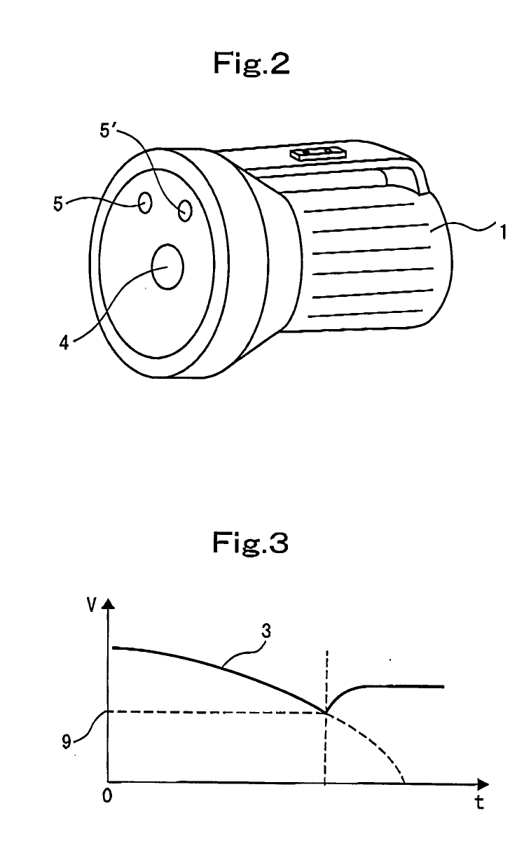

For example, as shown in FIG. 2, one HID lamp and two LEDs may be used for the first light source 4 and second light source 5 of the lighting apparatus 1, respectively.

In such a specific example, the number of the second light source 5, which influences the time length of driving the second light source 5, need to be decided based on the combination of power consumption of the second light source 5, capacity of the battery 2, and target operating time of the lighting apparatus 1.

The lighting apparatus 1 in accordance with the invention may be put to practical use as a flashlight, a lamp for disaster prevention, a lamp and head lamp for construction work, a lamp and head lamp for disaster relief work, a lamp for climbing, a fish lamp for fishing, and so on.

What is claimed is:

1. A lighting apparatus comprising:
a battery;
switch means;
at least two types of light sources, a power consumption of each being different from each other, capable of being connected to said battery via said switch means;
detection means for detecting an output voltage of said battery; and
switch control means for controlling said switch means to switch a connection target of said battery between said at least two types of light sources in response to an output signal of said detection means.

2. The lighting apparatus according to claim 1, wherein said battery is one selected from the group consisting of dry batteries, rechargeable secondary batteries, storage batteries, fuel cell batteries, and solar batteries.

3. The lighting apparatus according to claim 1, wherein said light sources include at least a first light source and a second light source, said second light source consuming less electric power than that of said first light source.

4. The lighting apparatus according to claim 3, wherein said first light source includes a high-intensity lamp, a halogen lamp, an HID lamp or a high-wattage lamp, and said second light source includes a low-intensity lamp, a low-wattage lamp or an LED lamp.

5. The lighting apparatus according to claim 3, wherein the number of said second light source is larger than that of said first light source.

6. The lighting apparatus according to claim 1, wherein said detection means detects that said output voltage of said battery falls below a predetermined voltage and outputs an information signal indicating a detection result.

7. The lighting apparatus according to claim 6, wherein said detection means detects said output voltage of said battery when the first light source is connected to said battery and lighted.

8. The lighting apparatus according to claim 7, wherein, when said first light source is connected to said battery and lighted, and if said detection means detects a predetermined voltage of said battery, said switch control means controls said switch means to disconnect said first light source from said battery and connect said second light source to said battery.

9. The lighting apparatus according to claim 6, wherein said predetermined voltage is a voltage level showing a condition at which said first light source is no more lighted.
